(19) United States
(12) Patent Application Publication
(10) Pub. No.: US 2013/0255383 A1
(43) Pub. Date: Oct. 3, 2013

(54) INERTIAL SENSOR AND POLLING METHOD USING THE SAME

(71) Applicants: Yu Heon Yi, Suwon (KR); Jun Lim, Suwon (KR)

(72) Inventors: Yu Heon Yi, Suwon (KR); Jun Lim, Suwon (KR)

(73) Assignee: SAMSUNG ELECTRO-MECHANICS CO., LTD., Suwon (KR)

(21) Appl. No.: 13/778,091

(22) Filed: Feb. 26, 2013

(30) Foreign Application Priority Data
Mar. 30, 2012 (KR) 10-2012-0032934

(51) Int. Cl. G01P 15/09

(52) U.S. Cl. CPC G01P 15/09
USPC 73/514.34

(57) ABSTRACT

Disclosed herein is an inertial sensor. The inertial sensor includes a sensor unit provided with an electrode layer and including piezo-electric elements so as to detect a movement of a driving unit supported to be able to be displaced to detect inertial force; an IC electrically connected to the sensor unit; and a switch connected between the sensor unit and an IC so as to control electrical connection between the sensor unit and the IC.

### CROSS REFERENCE TO RELATED APPLICATION

This application claims the benefit of Korean Patent Application No. 10-2012-0032934, filed on Mar. 30, 2012, entitled “Inertial Sensor and Polling Method Using the Same,” which is hereby incorporated by reference in its entirety into this application.

### BACKGROUND OF THE INVENTION

1. Technical Field

The present invention relates to an inertial sensor and a polling method using the same.

2. Description of the Related Art

Recently, as a small and light inertial sensor is easily manufactured using an MEMS technology, application fields of the inertial sensor have been expanded to home appliances including a mobile communication terminal beyond the existing market. Therefore, in accordance with the continuous development of functions of the inertial sensor, the function of the inertial sensor is being continuously developed from a uniaxial sensor capable of detecting only an inertial force for a single axis using a single sensor to a multi-axis sensor capable of detecting an inertia force for a multi-axis of two axes or more using a single sensor.

The inertial sensor according to the prior art including a prior art document as described above uses a piezo-electric element. The piezo-electric element may be deformed when being applied with voltage, but generates charges when being applied with force from the outside and as a result, has been used for various types of actuators, sensors, or the like. In addition, an example of the piezo-electric element may include various materials, such as Aln, ZnO, quartz, or the like, and PZT having a large piezo-electric constant has been used in various applications.

Meanwhile, after the piezo-electric elements are manufactured, most of the piezo-electric elements need to be subjected to a polling process before being operated so as to improve their own characteristics. The reason for performing the polling process is to improve the piezo-electric characteristics by applying heat and voltage.

However, as an IC and a sensor unit including piezo-electric elements are packaged, when applying high voltage for polling the sensor unit that is the piezo-electric element, the high voltage is applied to the IC and as a result, the IC may be damaged.

### PRIOR ART DOCUMENT

### Patent Document

(Patent Document 1) KR 2010-0129217A

### SUMMARY OF THE INVENTION

The present invention has been made in an effort to provide an inertial sensor including a switch that controls electrical connection between a sensor unit including piezo-electric elements and an IC so as to be able to prevent the IC from being damaged due to application of high voltage at the time of polling by switching-off the switch, and a polling method using the same.

According to a preferred embodiment of the present invention, there is provided an inertial sensor including: a sensor unit provided with an electrode layer and including piezo-electric elements so as to detect a movement of a driving unit supported to be able to be displaced to detect inertial force; an IC electrically connected to the sensor unit; and a switch connected between the sensor unit and the IC so as to control electrical connection between the sensor unit and the IC.

The sensor unit may include: a sensor unit electrode including a driving electrode for vibrating the driving unit and a sensing electrode detecting the movement of the driving unit; a sensor unit pad electrically connected to the IC to transfer a signal of the sensor unit to the outside and transfer the external signal to the sensor unit; and a sensor unit wiring electrically connecting the sensor unit electrode to the sensor unit pad.

The inertial sensor may further include: a package pad for polarization for applying external voltage to the sensor unit, wherein the sensor unit pad of the sensor unit is electrically connected to the package pad for polarization.

The IC may include: a sensor side IC pad electrically connected to the sensor unit; and an input and output IC pad transferring a signal of the IC to the outside and transferring the external signal to the IC.

The sensor side IC pad may be electrically connected to the sensor unit pad of the sensor unit.

The switch may include: a package side switch control pad transferring and receiving a signal from an outside of a package so as to control the switch; and a switch side switch control pad connected to the package side switch control pad.

The inertial sensor may further include: a package pad for polarization electrically connected to the sensor unit, receiving high voltage from an outside of a package for polling of the sensor, unit and transferring the high voltage to the sensor unit.

The inertial sensor may further include: an input and output package pad electrically connected to the IC to transfer a signal to the IC from an outside of a package and transfer the signal of the IC to the outside of the package.

According to another preferred embodiment of the present invention, there is provided a polling method of the inertial sensor as described above, the polling method including: determining whether a switch connected between a sensor unit and an IC is in a switch-on/off state; applying a switch-off signal when the switch is in a switch-on state; and applying high voltage for polling to the sensor unit.

According to another preferred embodiment of the present invention, there is provided a polling method including: applying a switch-off signal to a package side switch control pad; applying high voltage to a package pad for polarization; and performing a switch-on operation switching the switch into a switch-on state, wherein the performing of the switch-on operation may apply a switch-on signal to the package side switch control pad.

According to another preferred embodiment of the present invention, there is provided a polling method including: applying a switch-off signal to a package side switch control pad; applying high voltage to a package pad for polarization; and performing a switch-on operation switching the switch into a switch-on state, wherein the performing of the switch-on operation may maintain the package side switch control pad in a floating state.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic configuration view of an inertial sensor according to a first preferred embodiment of the present invention;

FIG. 2 is a detailed configuration diagram schematically showing an inertial sensor according to a second preferred embodiment of the present invention;

FIG. 3 is a flow chart schematically showing a polling method according to a first preferred embodiment of the present invention using the inertial sensor according to the preferred embodiment of the present invention;

FIG. 4 is a flow chart schematically showing a polling method according to a second preferred embodiment of the present invention using the inertial sensor according to the preferred embodiment of the present invention; and

FIG. 5 is a flow chart schematically showing a polling method according to a third preferred embodiment of the present invention using the inertial sensor according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the prior art would obscure the gist of the present invention, the description thereof will be omitted.

Hereinafter, preferred embodiments of the present invention are described in detail with reference to the accompanying drawings.

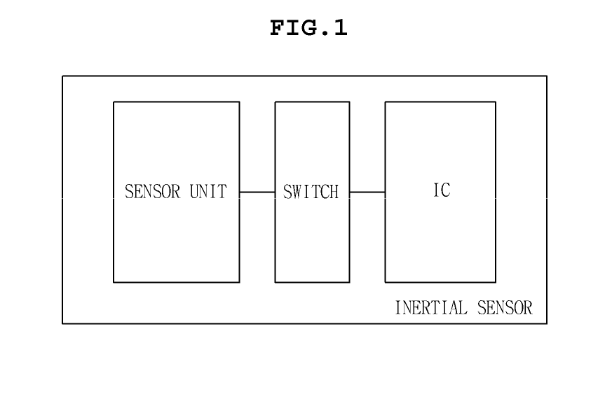

FIG. 1 is a schematic configuration view of an inertial sensor according to a first preferred embodiment of the present invention. As shown, FIG. 1 includes a packaged inertial sensor of FIG. 1, which includes a sensor unit, a switch, and an IC.

In more detail, the sensor unit is to detect inertial force that is angular velocity and acceleration and includes piezo-electric elements to vibrate a vibrator and is provided with an electrode layer to detect Coriolis force generated according to an effect of the angular velocity.

Further, the IC is electrically connected to the sensor unit and is implemented by a controlling IC or a detecting IC for the signal and temperature compensation, or the like, of the sensor unit.

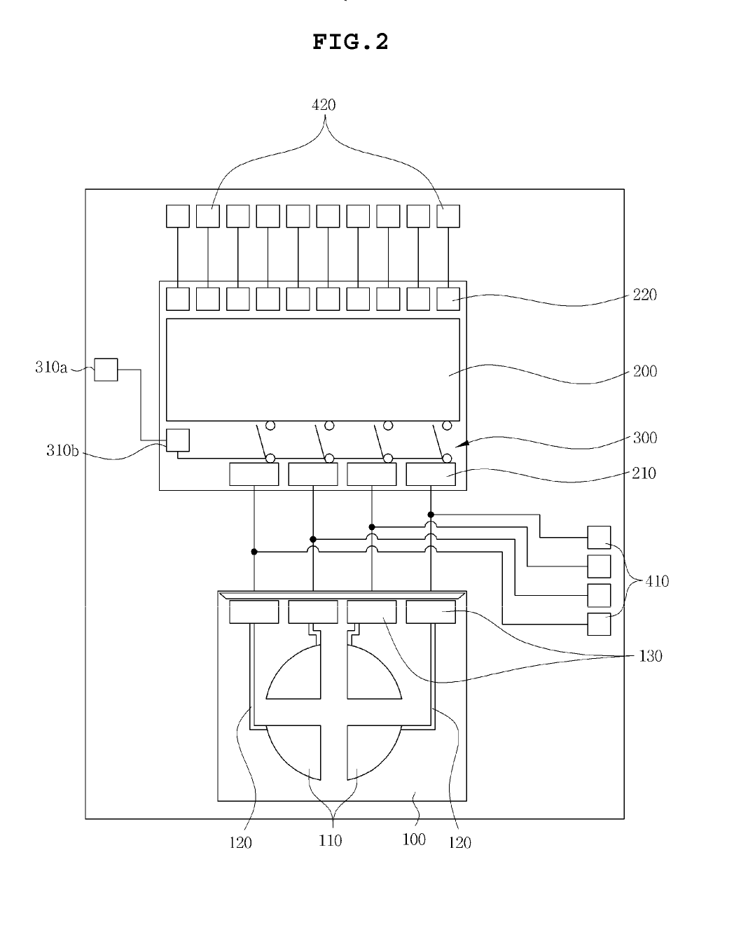

Further, the switch is to control electrical connection between the sensor unit and the IC. In more detail, the switch is to disconnect the electrical connection between the sensor unit and the IC at the time of polling the sensor unit. FIG. 1 shows the case in which the switch is separately provided in a package and may be implemented by a structure in which the switch is inserted into the IC as shown in FIG. 2.

According to the above configuration, when high voltage is applied for polling of the sensor unit that is the piezo-electric element, the damage of the IC can be prevented by interrupting the application of high voltage so that the high voltage is not applied to the IC by switching-off the switch.

FIG. 2 is a detailed configuration diagram schematically showing an inertial sensor according to a second preferred embodiment of the present invention. As shown in FIG. 2, the inertial sensor includes a sensor 100, an IC 200, and a switch 300.

In more detail, the sensor unit 100 includes the piezo-electric elements and includes a sensor unit electrode 110, a sensor unit wiring 120, and a sensor unit pad 130. Further, the sensor unit electrode 110 includes a driving electrode and a sensing electrode.

Further, the sensor unit 100 includes a driving unit supported so as to be able to be displaced by a support and the driving electrode is to vibrate the driving unit and the sensing electrode is to detect force in a predetermined direction that is applied to the driving unit. In addition, the sensor unit pad 130 is connected to the IC 200 to transfer the signal of the sensor unit 100 to the outside and to transfer the external signal to the sensor unit 100. Further, the sensor unit pad 130 is electrically connected to a package pad for polarization 410 to apply the external high voltage to the sensor unit.

To this end, the sensor unit wiring 120 electrically connects the sensor unit electrode 110 to the sensor unit pad 130.

Next, the IC 200 is electrically connected to the sensor unit 100 as described above and includes a sensor side IC pad 210 and an input and output IC pad 220. Further, the IC 200 may be implemented by the controlling IC and the detecting IC for the signal and temperature compensation, or the like, of the sensor unit 100. Further, the sensor side IC pad 210 is electrically connected to the sensor unit pad 130 of the sensor unit 100 to transfer the signal to the sensor unit 100 and receive the signal of the sensor unit.

In addition, the input and output IC pad 220 is to transfer the signal of the IC 200 to the outside and transfer the external signal to the IC 200. To this end, the input and output IC pad 220 is electrically connected to an input and output package pad 420.

In addition, the switch 300 is to control the electrical connection between the sensor unit 100 and the IC 200 as described above.

In more detail, the switch 200 is to disconnect the electrical connection between the sensor unit 100 and the IC 200 at the time of the polling of the sensor unit 100. To this end, the switch 300 includes switch control pads 310a and 310b. Further, the switch control pads 310a and 310b include a package side switch control pad 310a and a switch side switch control pad 310b.

Further, the package side switch control pad 310a is to receive the signal from the outside of the package so as to control the switch 300 and is to transfer the control signal of the switch to the outside of the package and is electrically connected to the switch side switch control pad 310b.

In addition, the package side switch control pad 310a does not apply a control signal and may use a switch that is switched-on in a floating state.

Further, the switch side switch control pad 310b receives the signal of the package side switch control pad 310a to switch-on/off the switch 300 and is electrically connected to the package side switch control pad 310 and the switch 300.

In addition, the inertial sensor according to the preferred embodiment of the present invention is formed as a packaged inertial sensor by further including the package pad for polarization 410 and the input and output package pad 420. The package pad for polarization 410 is applied with high voltage from the outside of the package for the polling of the sensor unit to transfer the high voltage to the sensor unit 100.

To this end, the package pad for polarization 410 is electrically connected to the sensor unit pad 130. In addition, as the sensor unit pad 130 is electrically connected to the sensor side IC pad 120, the package pad for polarization 410 is also electrically connected to the sensor side IC pad 210.

In addition, the input and output package pad 420 is to transfer the signal to the IC 200 from the outside of the package and transfer the signal of the IC 200 to the outside of the package. To this end, the input and output package pad 420 is electrically connected to the input and output IC pad 220.

According to the above configuration, the inertial sensor according to the preferred embodiment of the present invention applies a switch OFF signal to the switch control pad 310a, applies a switch OFF signal to the switch side switch control pad 310b, and switches-off the switch 300 connected to the IC when the high voltage is applied to the package pad for polarization 410 for the polling of the sensor unit 100.

In addition, when the high voltage for polling is applied to the package pad for polarization 410, the applied high voltage is applied to the sensor unit pad 130 and the high voltage applied to the sensor unit pad 130 is applied and polarized to the sensor unit electrode 110 through the sensor unit wiring 120.

As described above, after the polling is completed, the switch-on signal is applied to the switch control pad 310a, the switch-on signal is applied to the switch side switch control pad 310b, and the switch 300 connected to the IC is switched-on, such that the sensor unit 100 and the IC 200 are electrically connected to each other by the sensor side IC pad 210 and the sensor unit pad 130.

In addition, when the package side switch control pad 310a does not apply the control signal and uses the switched-on switch in the floating state, if the switch control pad 310a is in the floating state after the polling is completed, the switch 300 connected to the IC is switched-on, such that the sensor unit 100 and the IC 200 are electrically connected to each other by the sensor side IC pad 210 and the sensor unit pad 130.

Consequently, the damage of the IC occurring due to the application of the high voltage to the IC at the time of the polling can be prevented by electrically connecting selectively the sensor unit 100 to the IC 300 by the switch 200.

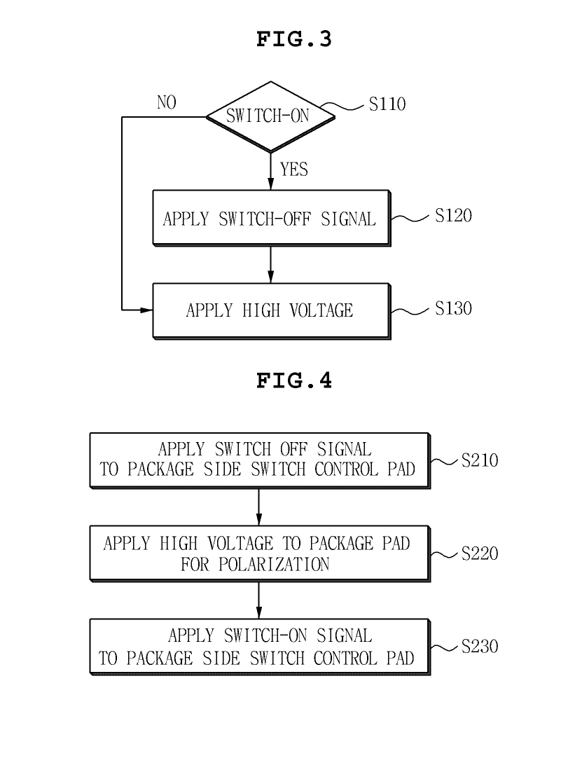

FIG. 3 is a flow chart schematically showing a polling method according to a first preferred embodiment of the present invention using the inertial sensor according to the preferred embodiment of the present invention. As shown, the polling method (S100) includes determining whether the switch connected between the sensor unit and the IC is in a switch-on state (S110), applying the switch signal (S120), and applying the high voltage (S130). In more detail, at the determining of the switch state, when the switch is in a switch-on state, the switch OFF signal is applied at the applying of the switch signal. Further, the high voltage for the polling is applied at the applying of the high voltage.

Meanwhile, when the switch is in a switch-off state, after the determining of the switch state (S110), the high voltage for the polling is applied at the applying of the high voltage.

FIG. 4 is a flow chart schematically showing a polling method according to a second preferred embodiment of the present invention using the inertial sensor according to the preferred embodiment of the present invention. As shown in FIG. 4, the polling method (S200) includes applying the switch-off signal to the package side switch control pad (S210), applying the high voltage to the package pad for polarization (S220), and applying the switch-on signal to the package side switch control pad that is the switch-on operating step of switching the switch in a switch-on state (S230).

In more detail, the switch-off signal is applied to the package side switch control pad. Therefore, the switch connecting the sensor unit to the IC is switched-off Further, when the high voltage is applied to the package pad for polarization, the high voltage applied to the package pad for polarization is applied to the sensor unit pad and is applied to the sensor unit electrode through the sensor unit wiring. As described above, when the polling of the sensor unit is completed and then, the switch-on signal is applied to the package side switch control pad, the switch connecting the sensor unit to the IC is switched-on and electrically connects the sensor unit to the IC.

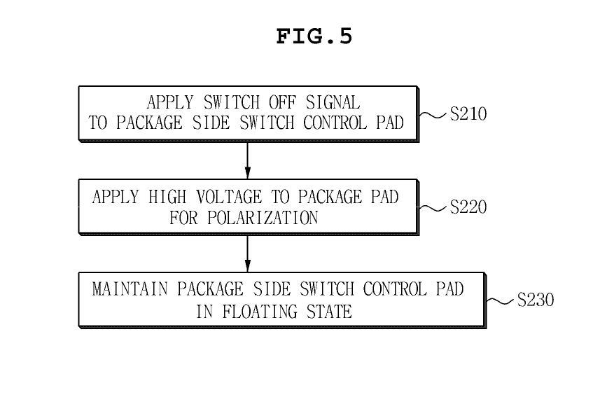

FIG. 5 is a flow chart schematically showing a polling method according to a third preferred embodiment of the present invention using the inertial sensor according to the preferred embodiment of the present invention. As shown, comparing the polling method according to the third preferred embodiment of the present invention with the polling method according to the second preferred embodiment of the present invention shown in FIG. 4, only the switch-on operation step switching the switch to the on state is different from each other.

To this end, when the switch is in the floating state without applying the control signal, the switched-off switch is used.

That is, the polling method (S300) includes applying the switch-off signal applying the switch-off signal to the package side switch control pad (S310), applying the high voltage to the package pad for polarization (S320), and maintaining the package side switch control pad in the floating state (S330).

Therefore, when the switch-off signal is applied to the package side switch control pad, the switch connecting the sensor unit to the IC is switched-off Further, when the high voltage is applied to the package pad for polarization, the high voltage applied to the package pad for polarization is applied to the sensor unit electrode and is applied to the sensor unit pad through the sensor unit wiring. As described above, when the polling of the sensor unit is completed and then, the package side switch control pad is in the floating state, the switch connecting the sensor unit to the IC is in a switch-on state and electrically connects the sensor unit to the IC.

According to the above configuration, when high voltage is applied for polling of the sensor unit that is the piezo-electric element, the damage of the IC can be prevented by interrupting the application of high voltage so that the high voltage is not applied to the IC by switching-off the switch.

The preferred embodiments of the present invention can provide the inertial sensor including the switch that controls the electrical connection between the sensor unit including the piezo-electric elements and the IC so as to be able to prevent the IC from being damaged due to the application of high voltage at the time of polling by switching-off the switch and the polling method using the same.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a sensor unit provided with an electrode layer and including piezo-electric elements so as to detect a movement of a driving unit supported to be able to be displaced to detect inertial force;
an IC electrically connected to the sensor unit; and
a switch connected between the sensor unit and the IC so as to control electrical connection between the sensor unit and the IC.

2. The inertial sensor as set forth in claim 1, wherein the sensor unit includes:
a sensor unit electrode including a driving electrode for vibrating the driving unit and a sensing electrode detecting the movement of the driving unit;
a sensor unit pad electrically connected to the IC to transfer a signal of the sensor unit to the outside and transfer the external signal to the sensor unit; and
a sensor unit wiring electrically connecting the sensor unit electrode to the sensor unit pad.

3. The inertial sensor as set forth in claim 2, further comprising: a package pad for polarization for applying external voltage to the sensor unit, wherein the sensor unit pad of the sensor unit is electrically connected to the package pad for polarization.

4. The inertial sensor as set forth in claim 1, wherein the IC includes:
a sensor side IC pad electrically connected to the sensor unit; and
an input and output IC pad transferring a signal of the IC to the outside and transferring the external signal to the IC.

5. The inertial sensor as set forth in claim 4, wherein the sensor side IC pad is electrically connected to the sensor unit pad of the sensor unit.

6. The inertial sensor as set forth in claim 1, wherein the switch includes:
a package side switch control pad transferring and receiving a signal from an outside of a package so as to control the switch; and
a switch side switch control pad connected to the package side switch control pad.

7. The inertial sensor as set forth in claim 1, further comprising: a package pad for polarization electrically connected to the sensor unit, receiving high voltage from an outside of a package for polling of the sensor unit, and transferring the high voltage to the sensor unit.

8. The inertial sensor as set forth in claim 1, further comprising: an input and output package pad electrically connected to the IC to transfer a signal to the IC from an outside of a package and transfer the signal of the IC to the outside of the package.

9. A polling method of an inertial sensor as set forth in claim 1, the polling method comprising:
determining whether a switch connected between a sensor unit and an IC is in a switch-on/off state;
applying a switch-off signal when the switch is in a switch-on state; and
applying high voltage for polling to the sensor unit.

10. A polling method, comprising:
applying a switch-off signal to a package side switch control pad;
applying high voltage to a package pad for polarization;
performing a switch-on operation switching the switch into a switch-on state.

11. The polling method as set forth in claim 10, wherein the operating of the switch-on applies a switch-on signal to the package side switch control pad.

12. The polling method as set forth in claim 10, wherein the operating of the switch-on maintains the package side switch control pad in a floating state.
